(19) United States
(12) Patent Application Publication
(10) Pub. No.: US 2006/0021698 A1
(43) Pub. Date: Feb. 2, 2006

(54) Applying glue using an injection molding machine

(76) Inventors: Bruce Pelle, Louisville, KY (US); Ken Tichenor, Corydon, IN (US); Mike Brickley, Louisville, KY (US)

Correspondence Address: Alexander J. Smolenski;Bromerg & Sunstein LLP, 125 Summer Street, Boston, MA, 02110-1618, US

(21) Appl. No.: 10/902,506

(22) Filed: Jul. 29, 2004

(51) Int. Cl. B29C 45/14; B32B 37/00; B29C 65/00

(52) U.S. Cl. 156/305; 264/259; 264/265; 264/250; 264/255; 264/328.1; 156/73.1; 156/73.6; 156/245; 156/307.1; 156/320

(57) ABSTRACT

A method of applying glue using an injection molding machine. The method includes providing a first substrate. The first substrate is inserted into a mold. A layer of glue is formed on the first substrate by injection molding glue into the mold. After allowing the glue to cure and removing the first substrate from the mold, a second substrate may be placed adjacent the layer of glue formed on the first substrate. The glue can then be reactivated, such as by applying heat, consequently binding the first substrate to the second substrate.

### CROSS REFERENCE TO RELATED APPLICATIONS

This application claims priority from U.S. provisional application No. 60/490,679, filed Jul. 29, 2003, which is incorporated herein by reference.

### TECHNICAL FIELD

The present invention relates to a method of applying glue using an injection molding machine.

### BACKGROUND ART

It is known in the prior art to manually apply glue to a substrate using a glue gun. While such a glue gun may be fairly inexpensive, manually applying glue to the substrate(s) is typically time and labor intensive, increasing costs and making the use of manual glue guns in high-volume production impractical. Furthermore, accuracy in dispensing the glue may become an issue in terms of both the amount and position of glue dispensed.

Alternatively, automated glue application machines can be utilized to apply glue to a substrate. Using an automated glue application machine has several advantages compared to a manual glue gun, such as being less labor and time intensive, and generally more accurate in terms of both position and amount of glue dispensed. However, automated glue application machines are typically much more expensive than manual glue guns.

Compounding this expense is that often a desired product is manufactured by injection molding a plurality of parts that are subsequently glued together. For example, a detergent container may be formed by injection molding, and gluing together, a bottle and a spout. Traditionally, this process has required purchasing both an automated glue gun application machine and an injection molding machine, further increasing costs.

In addition to cost considerations, various applications require more accuracy than can be achieved by current glue guns. For example, glue deposited by a glue gun onto a substrate may spread over the surface of the substrate, making the positioning and thickness of the deposited layer of glue unsatisfactory.

### SUMMARY OF THE INVENTION

In accordance with one aspect of the invention, there is provided a method of applying glue. The method includes providing a first substrate. The first substrate is inserted into a mold. A layer of glue is formed on the first substrate by injection molding glue into the mold.

After allowing the glue to cure and removing the first substrate from the mold, a second substrate may be placed adjacent the layer of glue formed on the first substrate. The layer of glue can then be reactivated based on, without limitation, at least one of heat, ultrasonic waves, vibration, and chemical interaction, consequently binding the first substrate to the second substrate. In various embodiments, the first substrate may be bonded to the second substrate at a remote location and/or at a later, more convenient time. For example, the first substrate and applied layer of glue may be shipped to a remote location for further processing.

In various embodiments of the invention, the glue may include ethylene vinyl acetate. Either or both the first substrate and the second substrate may include at least one of a metal and a plastic. One of the first substrate and the second substrate may be a plastic spout, and the other of the one of the first substrate and the second substrate may be a bottle. The first substrate may also be formed by injection molding. A second mold may be utilized, with material being injected into the molding to form the first substrate.

In accordance with another aspect of the invention, a multiple shot injection molding process using a single mold or multiple molds may be used. For example, in a first shot, material is injected into a mold to form the first substrate. A second shot injects a layer of glue onto the first substrate. The first substrate and layer of glue, upon curing and removal from the mold, form a first substrate that includes a layer of glue on one or more surfaces. A second substrate may then be bonded to the first substrate, as described above.

In accordance with another aspect of the invention, a method of applying glue includes providing a mold. A stand-alone layer of glue is formed by injection molding glue into the mold.

The stand-alone layer of glue may be placed adjacent at least one substrate, and reactivated to bond the at least one substrate to the layer of glue. For example, at least a portion of two substrates can be placed adjacent the layer of stand-alone glue that is then reactivated, joining the two substrates together. In other embodiments, the stand-alone layer of glue may be initially bonded only to a first substrate. At a later time, a second substrate may be placed adjacent the layer of glue formed on the first substrate. The layer of glue can then be reactivated to join the first and second substrates together.

### BRIEF DESCRIPTION OF THE DRAWINGS

The foregoing features of the invention will be more readily understood by reference to the following detailed description, taken with reference to the accompanying drawings, in which:

FIG. 1 shows an illustrative process of applying glue in accordance with illustrative embodiments of the invention;

FIG. 2 schematically shows a cross-sectional view of a substrate and mold in accordance with illustrative embodiments of the invention;

FIG. 3 schematically shows an injection molding system;

FIG. 4 shows an illustrative process of applying glue using multi-shot injection molding; and

FIG. 5 shows an illustrative process using injection molding to form a standalone layer of glue, in accordance with illustrative embodiments of the invention

### DETAILED DESCRIPTION OF SPECIFIC EMBODIMENTS

As used in this description and the accompanying claims, the term “glue” as used herein means any of various adhesive substances used to attach things together, unless the context otherwise requires.

In illustrative embodiments, a method of applying glue is presented. Generally, the method includes forming a layer of glue, either as a standalone product or on a substrate, using injection molding. The layer of glue can then be reactivated by heating or other methods known in the art, so as to attach various substrates together. Details are discussed below.

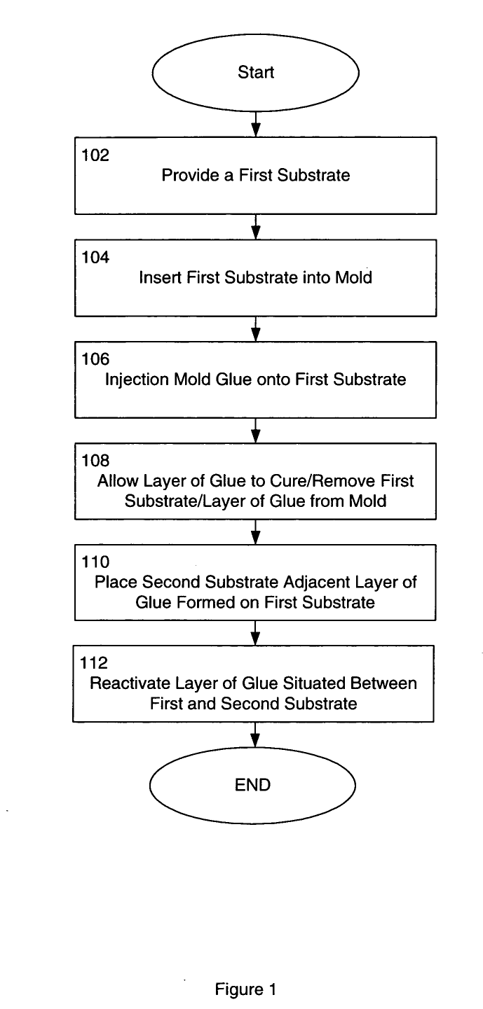

FIG. 1 shows a process of applying glue to a first substrate using an injection molding machine, in accordance with various embodiments of the invention. The process begins at step 102, in which a first substrate is provided. First substrate may be of varying shape, and be made of a wide variety of solid materials, such as, without limitation, a plastic or metal.

The process continues to step 104, in which the first substrate is inserted into a mold. Prior to placing the first substrate in the mold, the first substrate may be cleaned and degreased. This helps to ensure that any glue applied to a surface of the first substrate properly adheres to the surface.

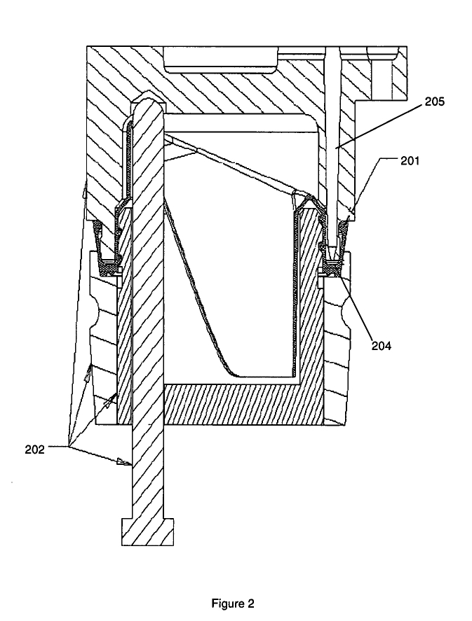

FIG. 2 schematically shows a cross-section of a first substrate 201 inserted into a mold 202 (i.e. after performing step 104 in the process depicted in FIG. 1), in accordance with one embodiments of the invention. The first substrate 201 in FIG. 2 is a plastic spout which is to be glued to the top of a bottle, however as described above, the first substrate 201 is not limited to this shape or material. The mold 202 firmly grasps the first substrate 201, and provides a cavity 204 into which glue will be injected. The mold also provides a gate 205 that provides a passageway between the outside of the mold and the cavity 204.

Referring back to FIG. 1, the process then continues to step 106, in which glue is injected into the mold, forming a layer of glue on the first substrate. This is accomplished using an injection molding machine. Examples of injection molding machines include, without limitation, the Toshiba Model ISG90V10-2B, the Niigata MD55S-IV, and the Ferromatik Roboshot 330i. The injection molding machine may be, for example, a vertical or horizontal injection molding machine, and may be, without limitation, a single shot machine having a single injection unit, or a multiple shot machine with multiple independent injection units, each of which may shoot a different material.

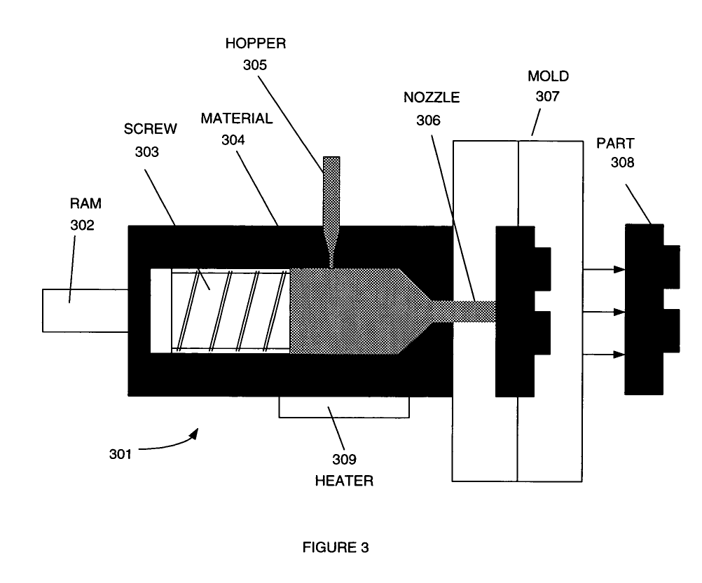

A schematic illustrating an exemplary injection molding machine 300 that can be used, for example, to implement step 106 of the process depicted in FIG. 1, is shown in FIG. 3. Hot, molten material 304 is inserted into a screw apparatus 303 via a hopper 305. One or more heater(s) 309 may be utilized to heat and prevent the material 304 from solidifying within the injection molding machine. The screw apparatus 303, in conjunction with ram 301, is used to inject the material 304 through a nozzle 306 into a mold 307. After the material 304 in the mold 307 cools and solidifies, the mold 307 is opened and the resulting part 308 extracted.

Referring back to FIGS. 1 and 2, molten glue from the injection molding machine's nozzle enters the outside port of gate 205 and flows into the cavity 204. Injection of the glue continues until the cavity 204 is filled. Since the glue dispensed is shaped/based on the characteristics of the cavity 204, excellent dispensing accuracy is achieved in terms of both thickness and positioning.

Glue may be, without limitation, hot melt glue such as Ethylene Vinyl Acetate (EVA). EVAs are made from a combination of solid thermoplastic polymers, tackifying resins and/or waxes that function with the right viscosity when properly heated. EVAs demonstrate strong adhesive properties and set quickly. Typically, hot melt glues are initially solid, and may be in the form, for example, of a pellet or stick. They are typically applied using heat. The heat reduces the glue to a molten state which exhibits excellent adhesive properties.

After applying the glue to the first substrate 204 by injection molding, the glue is allowed to cure on the first substrate 204, as shown FIG. 1, step 108. The glue cures by cooling to form a rapid, strong and durable bond across a surface of the first substrate 204. While curing and when sufficiently set, the first substrate is removed from the mold. First substrate, which now has a formed layer of glue on one or more of its surfaces, can now be packaged, stored and/or shipped if desired.

At a preferred time and place during the manufacturing process, a second substrate can be placed adjacent the layer of glue formed on the first substrate 204, as depicted in step 110. The layer of glue now situated between the first substrate and second substrate can then be reactivated based on at least one of heat, ultrasonic waves, vibration, and chemical interaction, consequently binding the first substrate to the second substrate, as depicted in step 112. To ensure proper binding, the second substrate may be clamped or otherwise pressed against the first substrate 204.

In accordance with related embodiments of the invention, the first and/or second substrate may be formed by injection molding, as known in the art. Injection molding of the first substrate, for example, may involve an injection molding process involving a second mold. The first substrate may then be provided and transferred to the mold as depicted in steps 102 and 104 of FIG. 1.

Alternatively, the first substrate may be formed and the glue applied in a multi-shot injection molding process involving a single mold. The injection molding machine may include multiple injection units, each of which is capable of shooting a different material.

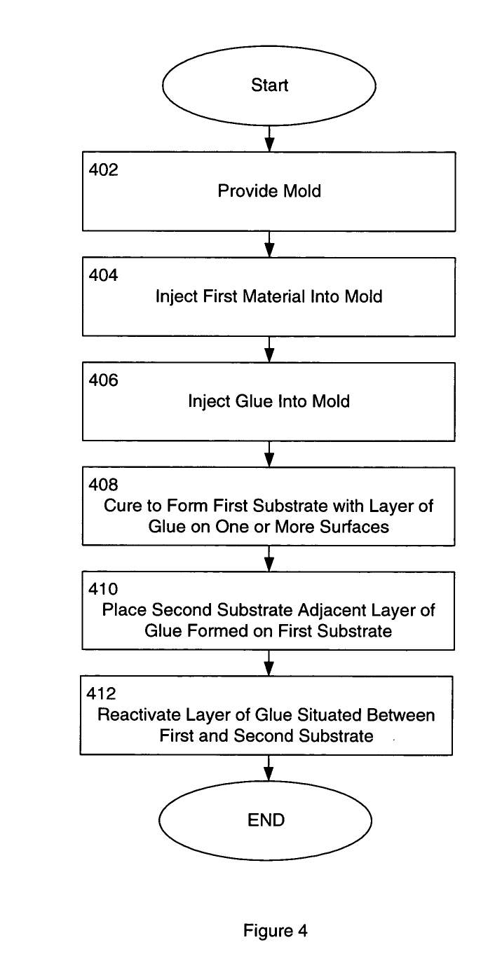

For example, FIG. 4 shows a process of applying glue using multi-shot injection molding, in accordance with an embodiment of the invention. A mold is provided in step 402. The mold contains at least one cavity into which material can be deposited. A first material, which may be, without limitation, a plastic or a metal, is injected into the mold in step 404. A layer of glue is then injected into the mold in step 406. Alternatively, the layer of glue may be injected first.

Upon curing in step 408, the materials form a first substrate that includes a layer of glue attached to one or more surfaces. Similar to above-described embodiments, at a preferred time and place during the manufacturing process, a second substrate can be placed adjacent the layer of glue formed on the first substrate, as depicted in step 410. The layer of glue now situated between the first substrate and second substrate can then be reactivated based on at least one of heat, ultrasonic waves, vibration, and chemical interaction, consequently binding the first substrate to the second substrate, as depicted in step 412.

In accordance with another aspect of the invention, instead of applying glue directly to a substrate as in the above-described embodiment of FIGS. 1 and 4, a standalone layer of glue is formed. The standalone layer of glue can be used, for example, to attach a plurality of substrates together.

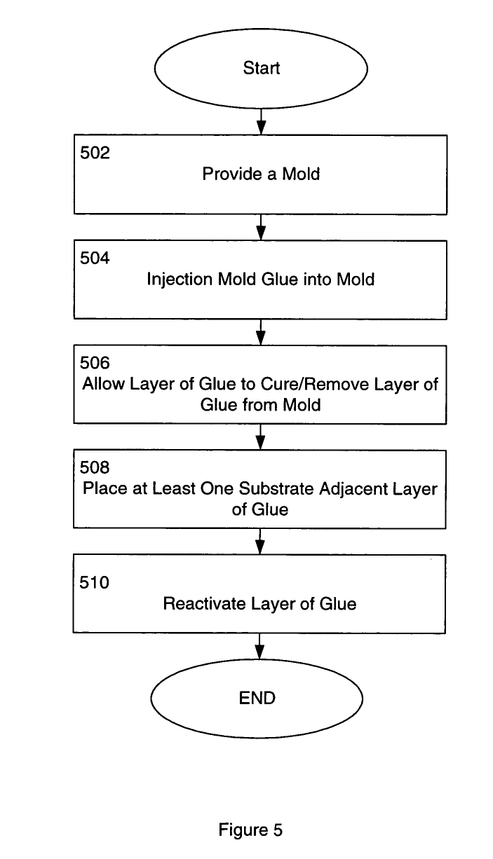

FIG. 5 shows a process that uses injection molding to form a standalone layer of glue, in accordance with various embodiments of the invention. The process begins with step 502 in which a mold is provided. The mold contains at least one cavity into which glue is to be deposited. The process then continues to step 504, in which glue is injection molded into the cavity forming a standalone layer of glue.

The stand-alone layer of glue is then allowed to cure and taken out of the mold in step 506. At this point, the standalone layer of glue can be, for example, shipped to and/or stored at a location to be utilized at a later time.

After curing, the stand-alone layer of glue may be placed adjacent at least one substrate, as depicted in step 508. The stand-alone layer of glue now situated adjacent the at least one substrate can then be reactivated based on at least one of heat, ultrasonic waves, vibration, and chemical interaction, as depicted in step 510. For example, at least a portion of at least two substrates can be clamped or otherwise pressed against each other with the standalone layer of glue positioned between the at least two substrates. The layer of stand-alone glue can then be heated, joining the at least two substrates together. In other embodiments, the stand-alone layer of glue may be initially bonded only to a first substrate. At a later time, a second substrate may be placed adjacent the layer of glue formed on the first substrate. The layer of glue can then be heated to join the first and second substrates together.

Although various exemplary embodiments of the invention have been disclosed, it should be apparent to those skilled in the art that various changes and modifications can be made that will achieve some of the advantages of the invention without departing from the true scope of the invention. These and other obvious modifications are intended to be covered by the appended claims.

What is claimed is:

1. A method of applying glue comprising:
providing a first substrate;
mating a mold to the first substrate; and
injection molding a glue into the mold to form a layer of glue on the first substrate.

2. The method according to claim 1, wherein the glue includes ethylene vinyl acetate.

3. The method according to claim 1, wherein the first substrate includes at least one of a metal and a plastic.

4. The method according to claim 1, further comprising cleaning the first substrate prior to injection molding.

5. The method according to claim 1, further comprising:
allowing the glue to cure on the first substrate.

6. The method according to claim 5, further comprising removing the first substrate from the mold.

7. The method according to claim 6, further comprising shipping the first substrate to a remote location.

8. The method according to claim 6, further comprising:
placing a second substrate adjacent the layer of glue on the first substrate; and
reactivating the layer of glue to bond the first substrate to the second substrate.

9. The method according to claim 8, wherein reactivating the layer of glue is based on at least one of heat, ultrasonic waves, vibration, and chemical interaction.

10. The method according to claim 8, wherein the second substrate includes at least one of a metal and a plastic.

11. The method according to claim 8, wherein placing the second substrate adjacent the layer of glue on the first substrate includes clamping the first substrate to the second substrate such that the second substrate is adjacent the layer of glue.

12. The method according to claim 8, wherein one of the first substrate and the second substrate is a plastic spout, and the other of one of the first substrate and the second substrate is a bottle.

13. The method according to claim 1, wherein providing a first substrate includes:
providing a second mold; and
injection molding material into the second mold to form the first substrate.

14. A method of applying glue comprising:
providing a mold;
injection molding a first material into the mold; and
injection molding a second material into the mold, wherein one of the first material and the second material is a glue.

15. The method according to claim 14, wherein the first material is one of a plastic and a metal, and the second material is the glue.

16. The method according to claim 14, further comprising:
allowing the glue to cure to form a first substrate that includes a layer of glue on one or more surfaces.

17. The method according to claim 16, further comprising removing the first substrate from the mold.

18. The method according to claim 17, further comprising shipping the first substrate to a remote location.

19. The method according to claim 16, further comprising:
placing a second substrate adjacent the layer of glue on the first substrate; and
reactivating the layer of glue to bond the first substrate to the second substrate.

20. The method according to claim 19, wherein reactivating the layer of glue is based on at least one of heat, ultrasonic waves, vibration, and chemical interaction.

21. The method according to claim 19, wherein the second substrate includes at least one of a metal and a plastic.

22. The method according to claim 19, wherein placing the second substrate adjacent the layer of glue on the first substrate includes clamping the first substrate to the second substrate such that the second substrate is adjacent the layer of glue.

23. The method according to claim 19, wherein one of the first substrate and the second substrate is a plastic spout, and the other of the one of the first substrate and the second substrate is a bottle.

24. A method of applying glue comprising:
providing a mold; and
injection molding a glue into the mold to form a standalone layer of glue.

25. The method according to claim 24, further comprising:
allowing the standalone layer of glue to cure; and
removing the standalone layer of glue from the mold.

26. The method according to claim 25, further comprising:
placing the standalone layer of glue adjacent a first substrate and a second substrate; and
reactivating the layer of glue to bond the first substrate to the second substrate.

27. The method according to claim 26, wherein reactivating the layer of glue is based on at least one of heat, ultrasonic waves, vibration, and chemical interaction.

28. The method according to claim 25, further comprising:
placing the standalone layer of glue adjacent a first substrate; and
reactivating the layer of glue to bond the standalone layer of glue to the first substrate.

29. The method according to claim 28, wherein reactivating the layer of glue is based on at least one of heat, ultrasonic waves, vibration, and chemical interaction.

30. The method according to claim 29, further comprising:
allowing the glue to cure on the first substrate.

31. The method according to claim 28, wherein the first substrate includes at least one of a metal and a plastic.

32. The method according to claim 30, further comprising shipping the first substrate to a remote location.

33. The method according to claim 30, further comprising:
placing a second substrate adjacent the standalone layer of glue on the first substrate; and
reactivating the layer of glue to bond the first substrate to the second substrate.

34. The method according to claim 33, wherein reactivating the layer of glue is based on at least one of heat, ultrasonic waves, vibration, and chemical interaction.

35. The method according to claim 33, wherein the second substrate includes at least one of a metal and a plastic.

36. The method according to claim 33, wherein placing the second substrate adjacent the layer of glue on the first substrate includes clamping the first substrate to the second substrate such that the second substrate is adjacent the layer of glue.

37. The method according to claim 33, wherein one of the first substrate and the second substrate is a plastic spout, and the other of one of the first substrate and the second substrate is a bottle.

38. The method according to claim 24, wherein the glue includes ethylene vinyl acetate.
